(19) United States
(12) Patent Application Publication
(10) Pub. No.: US 2024/0123384 A1
(43) Pub. Date: Apr. 18, 2024

(54) CARBON NANOTUBES-BASED FILTRATION MEDIA

(71) Applicant: MAAGAN FILTRATION ACA LTD., Kibbutz Maagan Michael (IL)

(72) Inventors: Uria BERCHMAN, Kibbutz Ma'agan Michael (IL); Oded ELISH, Kiryat Tiv'on (IL)

(21) Appl. No.: 18/277,429

(22) PCT Filed: Feb. 17, 2022
(86) PCT No.: PCT/IL2022/050194

§ 371 Date: Aug. 16, 2023

Related U.S. Application Data
(60) Provisional application No. 63/150,638, filed on Feb. 18, 2021.

(51) Int. Cl. B01D 39/20

(52) U.S. Cl. CPC B01D 39/2065; B01D 2239/0636; B01D 2239/065

(57) ABSTRACT

A filtration element comprising a thread-based medium comprising one or more threads, wherein each thread comprises at least one filament of carbon nanotube (CNT), and wherein the filtration element is configured to filter a feed fluid based on a filtration operation wherein the feed fluid passes through the thread-based medium.

### CROSS-REFERENCE TO RELATED APPLICATIONS

This application claims the benefit of priority from U.S. Provisional Patent Application No. 63/150,638, filed Feb. 18, 2021, entitled, “CARBON NANOTUBES-BASED FILTRATION MEDIA,” the contents of which are hereby incorporated by reference in their entirety.

### FIELD OF THE INVENTION

The invention relates to the field of filtration systems.

### BACKGROUND

Most commercial micro and ultrafiltration membranes applied for water and wastewater treatment are based on polymers such as polysulfone, polyvinylidene fluoride, polyacrylonitrile, polypropylene, polyester, and the like. Filtration media based on a polymeric active layer are typically prone to fouling problems when exposed to organic matter and bacteria, such as in wastewater filtration and treatment or seawater desalination. Furthermore, commercial polymeric filtration media have limited resistance to oxidation, for example, during cleaning-in-place (CIP), and are sensitive to thermal cleaning. Ceramic filtration media used in the pharmaceutical and food industry have high chemical and thermal resistance and are superior to polymeric media, however, they are significantly more expensive.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a filtration element comprising a thread-based medium comprising one or more threads, wherein each thread comprises at least one filament of carbon nanotube (CNT), and wherein the filtration element is configured to filter a feed fluid based on a filtration operation wherein the feed fluid passes through the thread-based medium.

In some embodiments, the thread-based medium comprises at least one continuous thread wound about a filter base in a series of windings defining at least one layer, wherein, during the filtration operation, the feed fluid passes between the series of windings in the at least one layer.

In some embodiments, the at least one continuous thread is a CNT thread.

In some embodiments, the at least one continuous thread is a yarn comprising at least one filament of CNT and at least one filament of a polymeric material.

In some embodiments, a ratio between a number of the filaments of CNT and the filaments of the polymeric material is one of: 1:1, 1:2, 1:3, 1:4, 1:5, 2:1, 3:1, 4:1, and 5:1.

In some embodiments, the filter base defines a planar body comprising at least one filtration face, wherein the feed fluid passes through the at least one layer to collect at the at least one filtration face, and wherein the collected feed fluid flows towards an outlet of the filtration element.

In some embodiments, the at least one filtration face comprises a plurality of protrusions which support the at least one layer to create a gap between the at least one layer and the at least one filtration face, wherein the feed fluid collects within the gap.

In some embodiments, the at least one filtration face comprises a plurality of openings, wherein the feed fluid flows through the plurality of openings to collect within a core of the filter base.

In some embodiments, the at least one continuous thread comprises at least one polymeric thread that is wound about the filter base in a series of windings defining at least one polymeric layer.

In some embodiments, the at least one polymeric layer is an outermost layer of the filtration element.

In some embodiments, the at least one layer is wound according to winding parameters selected from the group consisting of: a space between successive windings in the series of windings, and a tension applied to the thread during the winding.

In some embodiments, the filtration element comprises between 2-15 of the layers.

In some embodiments, the filter base is shaped as a sector of a planar ring, wherein a plurality of the filter bases are configured to be connected side-to-side to form the planar ring.

In some embodiments, a plurality of the planar rings are configured to be stacked, to form a stacked filtration unit, wherein the stacked filtration unit is housed within a housing to form a filtration system.

In some embodiments, the filter base comprises at least two electrodes configured to be in electric contact with at least a portion of the continuous thread, wherein the at least two electrodes are connected to an electric circuit configured to apply an electric voltage to the continuous thread.

In some embodiments, the at least one filament of CNT undergoes an electro-oxidation treatment.

In some embodiments, the thread-based medium comprises a plurality of the threads, wherein each of the threads comprises at least one filament of CNT, wherein the threads are arranged lengthwise into a sheaf between a first end and a second end of the medium.

In some embodiments, the plurality of threads are attached at the first end and are unattached at the second end.

In some embodiments, the medium is housed within a housing having a first opening and a second opening, wherein the first end is oriented toward the first opening of the housing, and the second end is oriented toward the second opening.

In some embodiments, the housing defines a cylindrical canister having a smaller cross-sectional first portion adjacent the first opening, and a larger cross-sectional second portion adjacent the second opening, wherein the thread-based medium is configured to move lengthwise within the housing between the first and second portions.

In some embodiments, (i) the first portion is configured to decrease a spacing between the plurality of threads when the thread-based medium is located within the first portion, and (ii) the second portion is configured to allow an increase in the spacing between the plurality of threads when the thread-based medium is located within the second portion.

In some embodiments, during the filtration operation, the feed fluid passes through the housing from the second opening substantially lengthwise along the threads toward the first opening, when the thread-based medium is located within the first portion.

In some embodiments, the thread-based medium is configured to be cleaned based on a cleaning cycle wherein a washing fluid passes through the housing from the first opening substantially lengthwise along the threads toward the second opening, when the thread-based medium is located within the second portion.

There is also provided, in some embodiment, a method comprising: providing a filtration element comprising a thread-based medium comprising one or more threads, wherein each thread comprises at least one filament of carbon nanotube (CNT), and wherein the filtration element is configured to filter a feed fluid based on a filtration operation wherein the feed fluid passes through the thread-based medium; and feeding, during the filtration operation, the feed fluid such that the feed fluid flows over the filtration element and passes through the thread-based medium.

In some embodiments, the thread-based medium comprises at least one continuous thread wound about a filter base in a series of windings defining at least one layer, and the method further comprises feeding the feed fluid such that the feed fluid passes between the series of windings in the at least one layer.

In some embodiments, the at least one continuous thread is a CNT thread.

In some embodiments, the at least one continuous thread is a yarn comprising at least one filament of CNT and at least one filament of a polymeric material.

In some embodiments, the filter base defines a planar body comprising at least one filtration face, wherein the feed fluid passes through the at least one layer to collect at the at least one filtration face, and wherein the collected feed fluid flows towards an outlet of the filtration element.

In some embodiments, the at least one filtration face comprises a plurality of protrusions which support the at least one layer to create a gap between the at least one layer and the at least one filtration face, wherein the feed fluid collects within the gap.

In some embodiments, the at least one filtration face comprises a plurality of openings, wherein the feed fluid flows through the plurality of openings to collect within a core of the filter base.

In some embodiments, the at least one continuous thread comprises at least one polymeric thread that is wound about the filter base in a series of windings defining at least one polymeric layer.

In some embodiments, the at least one polymeric layer is an outermost layer of the filtration element.

In some embodiments, the at least one layer is wound according to winding parameters selected from the group consisting of: a space between successive windings in the series of windings, and a tension applied to the thread during the winding.

In some embodiments, the thread-based medium further comprises between 2-15 of the layers.

In some embodiments, the filter base is shaped as a sector of a planar ring, wherein a plurality of the filter bases are configured to be connected side-to-side to form the planar ring.

In some embodiments, a plurality of the planar rings are configured to be stacked, to form a stacked filtration unit, wherein the stacked filtration unit is housed within a housing to form a filtration system.

In some embodiments, the filter base comprises at least two electrodes configured to be in electric contact with at least a portion of the continuous thread, wherein the at least two electrodes are connected to an electric circuit configured to apply an electric voltage to the continuous thread.

In some embodiments, the at least one filament of CNT undergoes an electro-oxidation treatment.

In some embodiments, the thread-based medium comprises a plurality of the threads, wherein each of the threads comprises at least one filament of CNT, wherein the threads are arranged lengthwise into a sheaf between a first end and a second end of the medium.

In some embodiments, the plurality of threads are attached at the first end and are unattached at the second end.

In some embodiments, the medium is housed within a housing having a first opening and a second opening, wherein the first end is oriented toward the first opening of the housing, and the second end is oriented toward the second opening.

In some embodiments, the housing defines a cylindrical canister having a smaller cross-sectional first portion adjacent the first opening, and a larger cross-sectional second portion adjacent the second opening, wherein the thread-based medium is configured to move lengthwise within the housing between the first and second portions.

In some embodiments, (i) the first portion is configured to decrease a spacing between the plurality of threads when the thread-based medium is located within the first portion, and (ii) the second portion is configured to allow an increase in the spacing between the plurality of threads when the thread-based medium is located within the second portion.

In some embodiments, the method further comprises feeding, during the filtration operation, the feed fluid through the housing from the second opening substantially lengthwise along the threads toward the first opening, when the thread-based medium is located within the first portion.

In some embodiments, the method further comprises feeding, during a cleaning cycle configured to clean the thread-based medium, a washing fluid through the housing from the first opening substantially lengthwise along the threads toward the second opening, when the thread-based medium is located within the second portion.

In addition to the exemplary aspects and embodiments described above, further aspects and embodiments will become apparent by reference to the figures and by study of the following detailed description.

### BRIEF DESCRIPTION OF THE FIGURES

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A-1B show an exemplary wound-thread filtration element in perspective and cross-section side views, according to some embodiments of the present disclosure;

FIGS. 2A-2B show an exemplary sheaf-based filtration device, according to some embodiments of the present disclosure;

FIGS. 3A-3D show several embodiments of an exemplary wound-thread filtration element, according to some embodiments of the present disclosure;

FIG. 4A shows an exemplary disc of a filtration system, according to some embodiments of the present disclosure;

FIG. 4B shows a cross section of a filter unit comprising multiple discs arranged in a stacked arrangement, according to some embodiments of the present disclosure;

FIG. 4C shows a filtration system comprising filter unit comprising multiple discs arranged in a stacked arrangement and arranged within a housing, according to some embodiments of the present disclosure;

FIG. 4D shows inlets and outlets of a filtration system comprising filter unit comprising multiple discs arranged in a stacked arrangement and arranged within a housing, according to some embodiments of the present disclosure;

FIGS. 5A-5D show cross-sectional views of a various exemplary embodiments of a yarn, according to some embodiments of the present disclosure;

FIGS. 6A-6B show an exemplary wound-thread filtration element in perspective and cross-section side views, according to some embodiments of the present disclosure;

FIG. 6C shows an exemplary electric circuit configured to apply electric voltage to an exemplary wound-thread filtration element, according to some embodiments of the present disclosure;

FIGS. 7A-7B show an exemplary sheaf-based filtration device, according to some embodiments of the present disclosure; and

FIGS. 8A-8D show experimental results of filtration using media of the present disclosure.

### DETAILED DESCRIPTION

Disclosed herein are systems, devices, and methods for filtration of fluids, using filter media which incorporate filaments or threads of carbon nanotube (CNT). In some embodiments, filtration media according to the present disclosure comprise one or more lengths of continuous CNT filaments, one or more lengths of continuous CNT threads (wherein each thread may comprise two or more individual filaments), and/or one or more lengths of yarn comprising CNT threads in combination with another type of filament or thread (e.g., polymeric filament or thread). In some embodiments, filtration media according to the present disclosure may use a single continuous CNT filament or thread, e.g., in wound form, and/or a plurality of lengths of continuous CNT filaments or threads, e.g., in bundle and/or sheaf form.

In some embodiments, CNT filaments or threads of the present disclosure may comprise any type of continuous CNT filaments according to any suitable diameters and/or cross-sectional shape and dimensions, e.g., single-wall carbon nanotubes (SWCNTs) with diameters in the nanometric range, multi-wall carbon nanotubes (MWCNTs) consisting of nested single-wall carbon nanotubes, and/or any other CNT in continuous filament form according to any suitable carbon-wall structure.

In some embodiments, the present disclosure provides for filtration elements comprising filtration media which incorporate one or more CNT filaments or threads. In some embodiments, CNT filaments or threads may be used exclusively; in combination with other types of threads; and/or in the form of spun yarns combining CNT threads and one or more other types of threads (e.g., polymeric thread). In some embodiments, filtration media of the present disclosure may comprise, e.g., filament-wound or thread-wound filtration media and/or sheaf-based and/or bundle-based filtration media.

Also disclosed herein is a multi-filament or multi-thread continuous yarn for use in filtration media, and an associated method for usage thereof. In some embodiments, the multi-filament or multi-thread yarn of the present disclosure comprises one or more continuous CNT filaments or yarns in combination with one or more other thread types, e.g., one or more polymeric threads.

As used herein, the term ‘filament’ refers to a length of a single continuous fiber of a single material (e.g., a polymer or CNT). The term ‘thread’ refers to a continuous length of a thread comprising two or more fibers or filaments, typically of the same material. The term ‘yarn’ refers broadly to a continuous length of thread comprising filaments or fibers of more than one martials (e.g., CNT and polymer), wherein the individual filaments or fibers are interlocking and/or twisted and/or spun and/or texturized.

By way of background, a fluid filter element is designed to remove solid particles or other impurities from a fluid (liquid and/or gas) by means of a porous physical barrier. Fluid filtration systems for hydraulic fluids are generally considered to be efficient and cost-effective. However, in filtration applications where the fluid feed contains high levels of organic matter, such systems are often susceptible to biological contamination and biofouling due to accumulation of microorganisms or other organic matter that cause degradation in the functioning of the filter media. Most often, this issue arises in such applications as wastewater and effluent treatment, seawater filtration and/or desalination, surface water filtration (e.g., in lakes, reservoirs and rivers), brackish water desalination pre-treatment (rivers & well water), municipal WWTP (wastewater treatment plant) tertiary effluent, industrial applications (process and re-use), industrial wastewater tertiary effluent, and swimming pool filtration.

Thus, as the filtration media comes in contact with the fluid feed, the high concentrations of organic matter and bacteria in the feed causes foulants to remain deposited and grow within the media. Among other things, biofouling may cause a decrease in water flux of the media and an increase in differential pressure within the filtration system, require more frequent chemical cleanings and treatments, and ultimately may result in clogging and loss of efficiency, requiring filter replacement. Thus, biofouling is a major cause of increases in operational expenses in hydraulic fluid filtration systems.

Accordingly, in some embodiments, the present disclosure provides for CNT-based filtration media, such as wound CNT thread filtration elements and/or sheaf-based filtration devices, configured to minimize biofouling. In some embodiments, the filtration media of the present disclosure are comprised entirely of CNT threads or incorporate CNT filaments and/or CNT-based yarns in combination with other materials (e.g., polymeric threads). In some embodiments, incorporating CNT filaments and/or yarns in the filtration media modifies one or more properties of the media, including, but not limited to:
Antimicrobial properties,
hydrophilicity/hydrophobicity properties,
mechanical properties (e.g., tensile strength, elastic modulus),
resistance to a wide range of chemicals,
thermal stability (e.g., up to 400° C.), and/or
electrical conductivity properties (up to ˜40,000 S/m).

In some embodiments, the inherent antimicrobial properties of CNT may inhibit the growth of a biofilm within the media, and, consequently, reduce the development of biofouling in the media. In this regard, CNT offers promising potential to engage with biological molecules. In particular, a number of carbon-based nanomaterials have been found to possess powerful bactericidal properties toward pathogenic microorganisms. The mechanism by which CNT inactivate bacteria is complex and depends on intrinsic properties of CNT, e.g., composition and surface modification, the nature of the target microorganisms, and the characteristics of the environment in which biological cells interact with CNT. However, in principle, the bactericidal action of CNT typically involves a combination of physical and chemical mechanisms. Physically, CNT may cause considerable structural damage to the cell wall and membrane of the microorganism. Furthermore, carbon nanomaterials such as graphene sheets are capable to biologically isolate cells from their microenvironments, which may eventually lead to cell death. Chemical interaction between CNT and the microorganism surface may lead to generation of toxic substances, such as reactive oxygen species (ROS), placing the cell under oxidative stress. The interactions between CNT and cells may cause an electron transfer phenomenon, where electrons are progressively drained from the microbial outer surface, which may cause ROS-independent oxidative stress, leading to the biological death.

In some embodiments, a filtration media incorporating CNT filaments or threads according to some embodiments of the present disclosure may provide for one or more advantages, e.g.:
Extended filter service life;
longer intervals between replacements of media by 20-30%;
ability to handle wastewater and effluent with higher loads of contaminant particles;
less expected backwashes by 15-20% compared common fibrous filter media, due to stability in the initial ΔP;
less need for chemical cleanings due to less biofouling overall; and/or
reduction in number of living bacteria and viruses in the main filtrate stream.

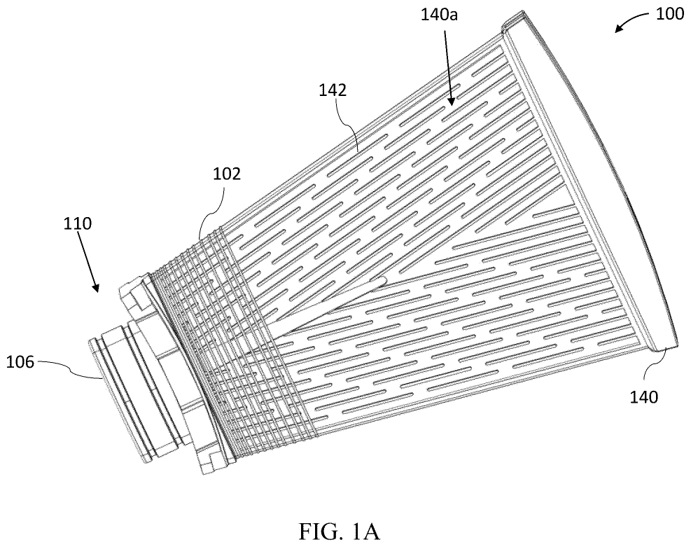

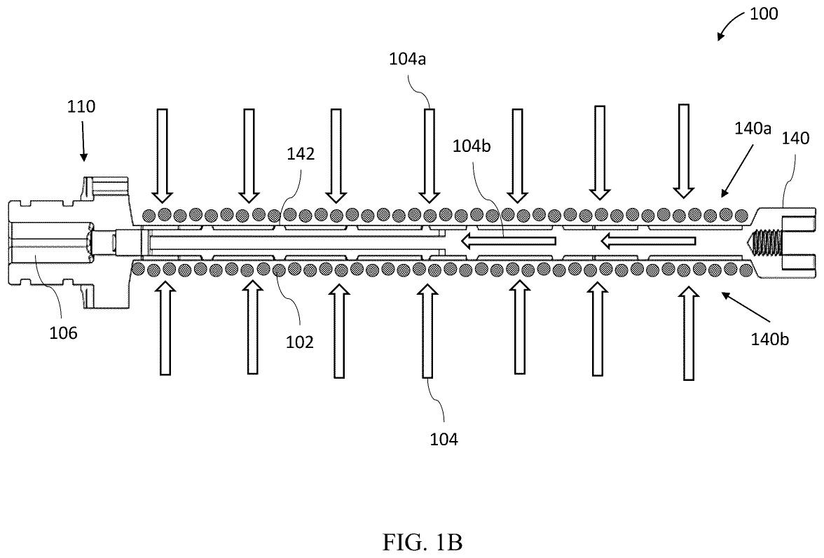

Reference is made to FIGS. 1A-1B, which show an exemplary wound-thread filtration element 100 in perspective (FIG. 1A) and a longitudinal cross-sectional side (FIG. 1B) views, according to some embodiments of the present disclosure. Wound-thread filtration element 100 may be configured as detailed in International Application No. PCT/IL2018/051310 filed on Nov. 29, 2018, the entire contents of which are also incorporated herein by reference.

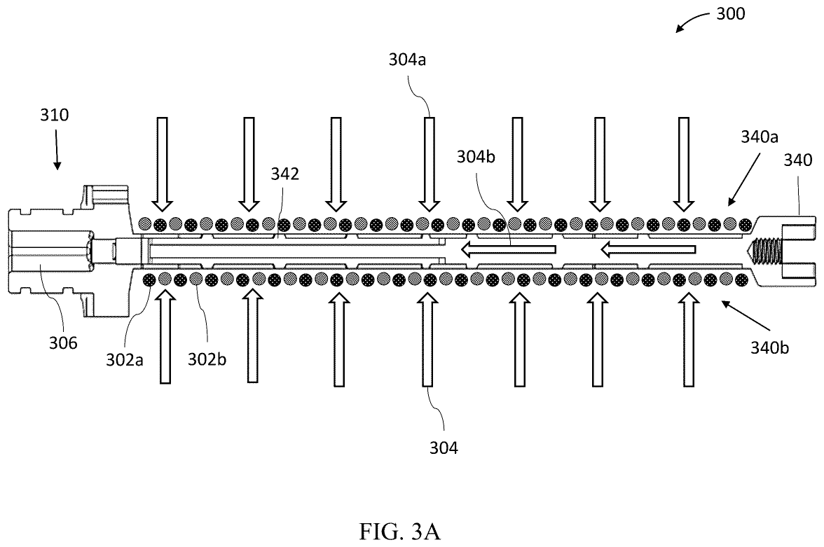

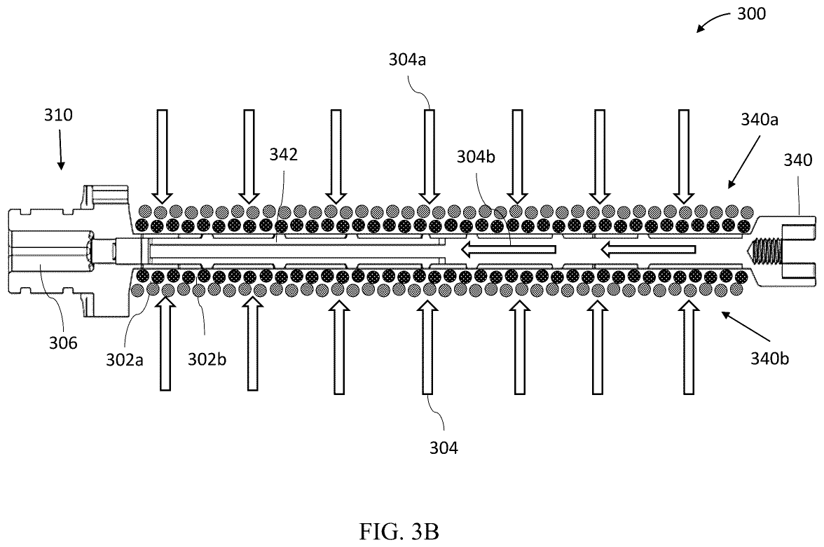

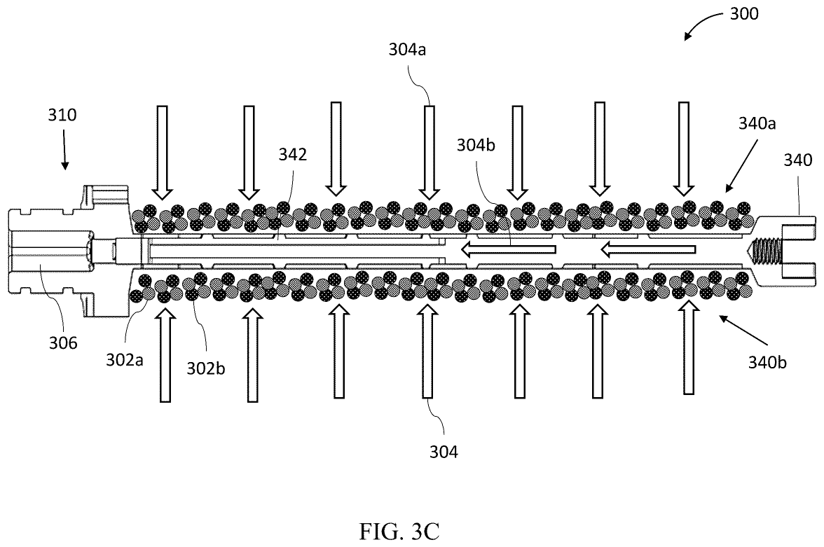

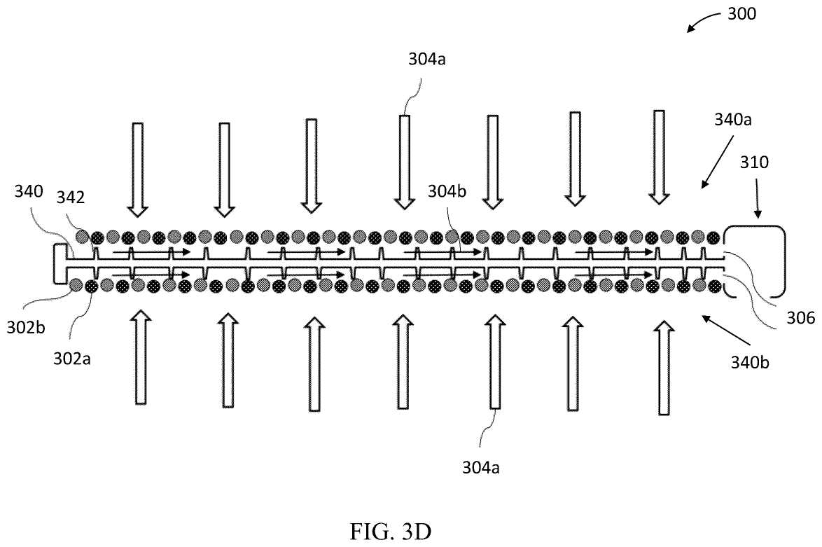

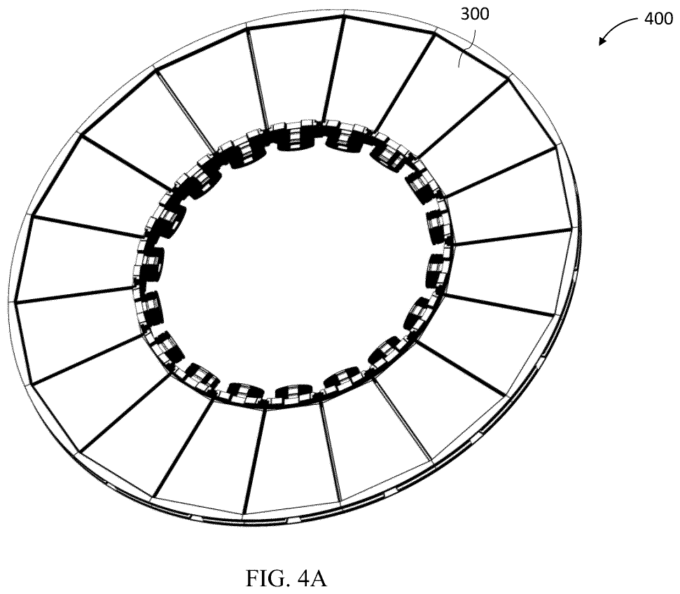

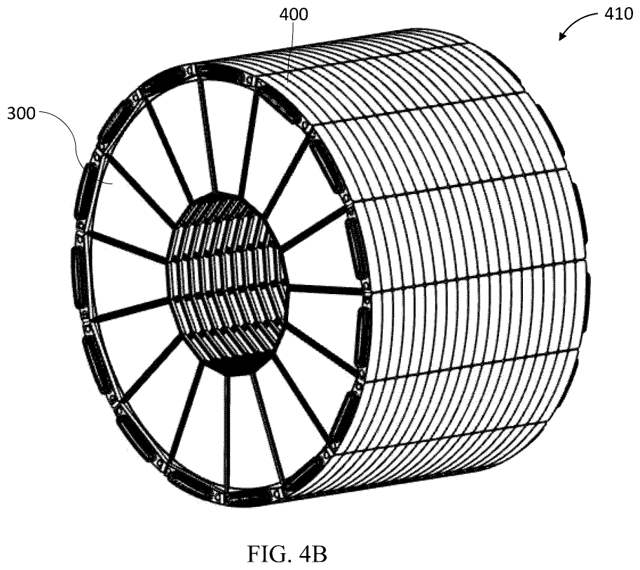

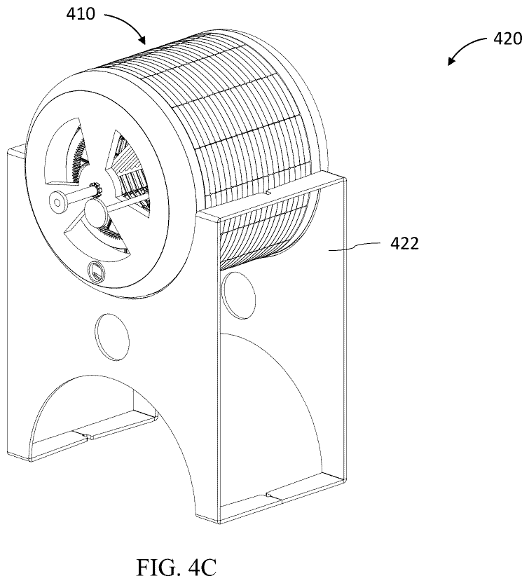

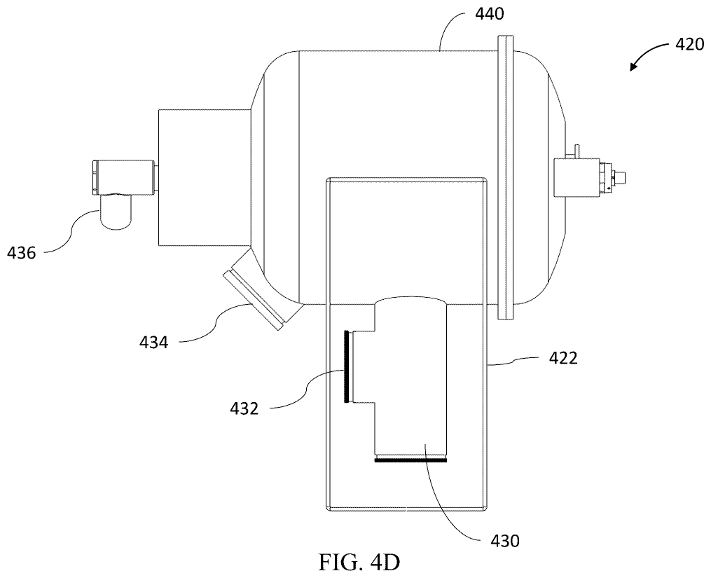

As can be seen in FIG. 1A, in some embodiments, element 100 may be constructed from a base 140 defining, e.g., a planar trapezoidal shape and/or another shape which may form a sector of a planar ring and/or disc when assembled side-to-side with additional like elements. In some embodiments, element 100 may be shaped to be arranged with like elements into a planar ring-shape arrangement, to form a filtration disc for use within a disc-based filtration system, as shall be further detailed below with reference to FIGS. 4A-4D. In some embodiments, base 140 comprises at least one filtration face or surface 140a, 140b, comprising supports or protrusions 142 thereon, and is wrapped by a thread 102 which is wound about a circumference of base 140 and over protrusions 142, to form a filtration media or filtration substrate. Thread 102 can be made according to any continuous filament, fiber, or thread type, typically in known filtration systems, a polymeric thread. In some embodiments of the present disclosure, as shall be further detailed hereinbelow with reference to FIGS. 3A-3D, thread 102 may be made entirely of, or incorporate, CNT filaments and/or threads, e.g., alone or in combination with other one or more types of threads (e.g., polymeric threads).

Protrusions 142 are configured to maintain a small gap between wound thread 102 and one or more faces or surfaces 140a, 140b of base 140. During a filtration cycle, feed fluid is passed over wound thread 102 and, through the operation of a pressure differential, is filtered through the one or more layers of wound thread 102 in a direction 104a (shown in FIG. 1B) generally perpendicular to faces or surfaces 140a, 140b of base 140, as indicated by arrows. Particles in the feed fluid are trapped in the spacing between the windings of thread 102, wherein, in a multi-layer arrangement, different layers of the windings may trap different size particles, ranging from about 25-40 microns at the outermost winding layer, to about 1-10 microns at the innermost winding layer, nearest faces or surfaces 140a, 140b. After passing between the windings of thread 102, the filtered feed fluid is collected and flows over the faces or surfaces 140a, 140b of base 140, within the gap created by protrusions 142 between thread 102 and faces or surfaces 140a, 140b of base 140, towards an outlet 106 located at an end portion 110 of element 100, and out through outlet 106 of element 100. In some embodiments, after passing between windings of thread 102, the filtered feed fluid may then pass through openings (not shown) in the faces or surfaces 140a, 140b of base 140, and then collect at a channel within a core of base 140, wherein it flows in an axial direction 104b (shown in FIG. 1B) towards outlet 106 located at an end portion 110 of element 100, and out through outlet 106 of element 100. In some embodiments, in a rinsing cycle, element 100 of the present disclosure may be cleaned to release dislodged particles which are trapped in the inter-thread spacing. For example, a rinsing system (not shown) may spray a cleaning fluid over a one or more surfaces of element 100, through a nozzle system.

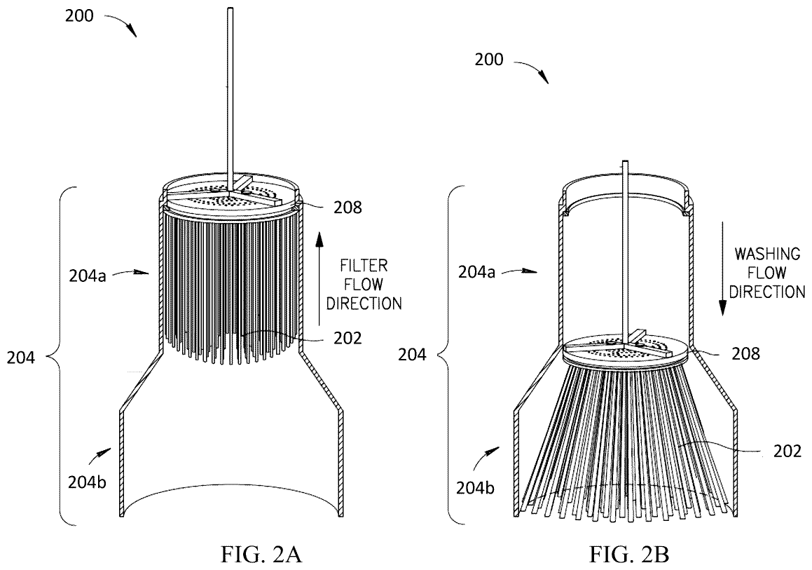

FIGS. 2A-2B show an exemplary sheaf-based filtration device 200 according to some embodiments of the present disclosure. Sheaf-based filtration device 200 may be configured as detailed in International Application No. PCT/IL2014/050800 filed on Sep. 9, 2014, the entire contents of which are incorporated herein by reference.

In some embodiments, sheaf-based filtration device 200 comprises a sheaf-based media, e.g., sheaf 202, comprising multiple yarns or threads. In some embodiments, sheaf 202 comprises a plurality of lengths of filaments or yarns arranged in a lengthwise arrangement and attached at one end, e.g., to a perforated plate 208. In some embodiments, sheaf 202 may be made entirely of, or incorporate, CNT filaments and/or threads, e.g., alone or in combination with other one or more types of threads (e.g., polymeric threads). Sheaf 202 may be held within a cylindrical canister 204, which has a smaller cross-sectional area portion 204a and a larger cross-sectional area portion 204b. In some embodiments, portion 204a may be dimensioned for accommodating sheaf 202 in a tight fit. During a filtration stage, fluid passes within cylindrical canister 204 in a filtration flow direction, as indicated in FIG. 2A. The fluid pressure urges sheaf 202 from portion 204b into portion 204a of cylindrical canister 204, wherein the smaller cross-sectional area compresses sheaf 202 and decreases inter-thread spacing within sheaf 202. The fluid typically flows substantially lengthwise along the threads of the sheaf, wherein particles may be trapped within the inter-thread spacing.

In some embodiments, as shown in FIG. 2B, sheaf-based filtration element 200 may be configured for performing a back-wash cleaning cycle, wherein the filtration element 200 is operated in a reverse flow direction, to release dislodged particles which are trapped in the inter-thread spacing. During such a cleaning cycle, a washing fluid may flow in a washing flow direction, as indicated in FIG. 2B, thereby urging sheaf 202 from portion 204a into larger-diameter portion 204b. The greater cross-sectional area of portion 204b allows the individual threads of sheaf 202 to loosen, thereby increasing inter-thread spacing. The washing fluid then flows substantially lengthwise along the length of the threads, thereby dislodging particles attached to the threads of sheaf 202, and carrying them away in the flow direction.

FIGS. 3A-3D show several embodiments of an exemplary wound-thread filtration element 300 in a longitudinal cross-sectional side view, according to some embodiments of the present disclosure. Element 300 may be constructed from a base 340 defining, e.g., a trapezoidal shape and/or another shape which may form a sector of a planar ring or a disc. In some embodiments, element 300 may be shaped to be arranged with like elements into a planar ring-shape arrangement, to form a filtration disc for use within a disc-based filtration system, as shall be further detailed below with reference to FIGS. 4A-4D. In some embodiments, base 340 comprises at least one filtration face or surface 340a, 340b comprising supports or protrusions 342 thereon, and is wrapped by a thread 302 which is wound about a circumference of base 340 and over protrusions 342, to form a filtration media or filtration substrate. Thread 302 may incorporate CNT filaments or threads alone or in combination with one or more other types of threads, e.g., polymeric threads. Protrusions 342 are configured to maintain a small gap between wound thread 302 and one or more faces or surfaces 340, 340b of base 340. During a filtration cycle, feed fluid is passed over wound thread 302 and, by the operation of a pressure differential, is filtered through one or more layers of wound thread 302 in a direction 304a generally perpendicular to faces or surfaces 340a, 340b of base 340. Particles in the feed fluid are trapped in the spacing between windings of thread 302, wherein, in a multi-layer arrangement, different layers of the windings may trap different size particles, ranging, e.g., from about 25-40 microns at the outermost winding layer to about 1-10 microns at the innermost winding layer, nearest faces or surfaces 340a, 340b. After passing between windings of thread 302, the filtered feed fluid then flows over the faces or surfaces 340a, 340b of base 340, within the gap between thread 302 and a surface of base 304, in a direction 304b towards an end portion 310 of element 300, and ultimately out through outlet 306 of element 300. In some embodiments, after passing between windings of thread 302, the filtered feed fluid may then pass through openings (not shown) in the faces or surfaces 340a, 340b of base 340, and then collect at a channel within a core of base 340, wherein it flows in a direction 304b towards outlet 306 located at an end 310 portion of element 300, and ultimately out through outlets 306 of element 300. In some embodiments, in a rinsing cycle, element 300 of the present disclosure may be cleaned to release dislodged particles which are trapped in the inter-thread spacing. For example, a rinsing system (not shown) may spray a cleaning fluid over a one or more surfaces of element 300, through a nozzle system.

In some embodiments, the present disclosure provides for a wound-thread filtration media, e.g., element 300 in FIGS. 3A-3D, wherein thread 302 incorporates CNT filaments and/or comprises a combination of CNT filaments and one or more types of polymeric threads, wherein the winding may comprise, e.g.:
Multiple filaments of CNT and polymeric threads in various numbers and ratios;
a yarn comprising multiple CNT filaments and polyester threads in various numbers and ratios;
layers of CNT filaments or threads and polymeric threads, e.g., alternate layers or polymeric threads layering over an inner layer of CNT threads or yarn; and/or
a net and/or any other type of permeable covering applied to the CNT layers to prevent migration of the CNT filaments into other layers.
dipping in and/or applying a suitable coating, e.g., PVDF or the like.

In some embodiments, a wound thread filtration media of the present disclosure, such as depicted in FIGS. 3A-3D, may be configured to provide for fine filtration of particles within the range of, e.g., 1-10 μm. In some embodiments, a wound thread filtration media of the present disclosure may provide for controlling of filtration parameters by modifying one or more of:
Material type: CNT filaments alone, one or more types of polymeric threads alone, or CNT filaments in combination with one or more types of polymeric threads.
Material properties of wound threads: Texturization of threads (friction texture, air texture), tensile strength, stretch parameters, yarn twist properties (e.g., S or Z twist), fusing of filaments, etc.
Dimensional properties of the thread: Filament diameter, number of filaments in a thread, thread diameter (e.g., between 120-180 microns).
Winding parameters: Space between wound filaments (e.g., step during winding process), number of wound layers, thread tension (which may be varying in different section of the media), method of securing the threads to the media (e.g., adhesion, etc.).

With continued reference to FIGS. 3A-3D, shown are schematic cross-sectional side views of several embodiments of an exemplary wound-thread filtration element 300 of the present disclosure, wherein the wound threads comprise a combination of CNT filaments and one or more types of polymeric threads.

For example, in FIG. 3A, element 300 is wound using a single layer comprising two or more kinds of filaments or threads, wherein reference numeral 302a designates CNT filaments or threads (e.g., single filaments or threads comprising two or more filaments, e.g., between 2 and 10 filaments), and reference numeral 302b designates polymeric threads of one or more types. The combination of CNT and polymeric threads may comprise various ratios of a number of CNT filaments or threads to a number of polymeric threads, e.g., 1:1, 1:2, 1:3, 1:4, 1:5, 2:1, 3:1, 4:1, 5:1, etc.

In an example embodiment depicted in FIG. 3B, element 300 is wound using two or more layers of windings, each comprising two or more kinds of filaments or threads—e.g., reference numeral 302a designates CNT filaments or threads (e.g., single filaments or threads comprising two or more filaments, e.g., between 2 and 10 filaments), and reference numeral 302b designates polymeric threads of one or more types. The combination of CNT and polymeric threads may comprise two or more layers, e.g., 3, 4, 5, 6, 7, 8, 9, 10 layers, or more, wherein a ratio between a number of layers of CNT filaments or threads to a number of layers of polymeric threads may be, e.g., 1:1, 1:2, 1:3, 1:4, 1:5, 2:1, 3:1, 4:1, 5:1, etc. In some embodiments, an innermost layer of element 300 in relation to faces or surfaces 340a, 340b of base 340 may comprise CNT filaments or threads only, wherein one or more subsequent winding layers may comprise polymeric threads. Such an arrangement takes advantage of the desirable antibacterial properties of a CNT-based winding layer to prevent biofouling at the faces or surfaces 340a, 340b of base 340 of element 300, where cleaning is less efficient and wherein the faces or surfaces 340a, 340b provide a growth area for bacteria colonies.

In an example embodiment depicted in FIG. 3C, element 300 is wound using a yarn 312, i.e., a continuous length comprising multiple individual filaments or threads. In some embodiments, yarn 312 may comprise two or more individual CNT filaments or threads in combination with one or more polymeric thread types. In some embodiments, yarn 312 may comprise two or more individual filaments or threads, e.g., 2, 3, 4, 5, 6, 7, 8, 9, 10, or more filaments or threads, wherein a ratio between a number of filaments or threads of CNT to a number of polymeric threads may be, e.g., 1:1, 1:2, 1:3, 1:4, 1:5, 2:1, 3:1, 4:1, 5:1, etc. In some embodiments, a yarn of the present disclosure incorporating CNT filaments or threads may comprise filaments or threads having varying degrees of tensile strength, tenacity, elongation properties, and/or diameters. In some embodiments, threads incorporated into a yarn of the present disclosure may undergo texturizing using, e.g., varying degrees of crimp contraction.

In an example embodiment depicted in FIG. 3D, element 300 is wound using a single layer comprising two or more kinds of filaments or threads, wherein reference numeral 302a designates CNT filaments or threads (e.g., single filaments or threads comprising two or more filaments, e.g., between 2 and 10 filaments), and reference numeral 302b designates polymeric threads of one or more types. The combination of CNT and polymeric threads may comprise various ratios of a number of CNT filaments or threads to a number of polymeric threads, e.g., 1:1, 1:2, 1:3, 1:4, 1:5, 2:1, 3:1, 4:1, 5:1, etc. Base 340 comprises supports or protrusions 342 on its faces or surfaces 340a, 340b, and is wrapped by the thread which is wound about a circumference of base 340 and over protrusions 342, to form a filtration media or filtration substrate. Protrusions 342 are configured to maintain a small gap between wound thread 302a, 302b and one or more faces or surfaces 340a, 340b of base 340. During a filtration cycle, feed fluid is passed over wound thread 302a, 302b and, through the operation of a pressure differential, is filtered through one or more layers of wound thread 302a, 302b in a direction 304 substantially perpendicular to a plane of base 340, as indicated by arrows. Particles in the feed fluid are trapped in the spacing between windings of thread 302a, 302b. After passing between windings of thread 302a, 302b, the filtered feed fluid then flows over the surface of base 340, within the gap between thread 302a, 302b and a surface of base 340, in an axial direction 304b indicated by arrows towards an outlet 306 located at an end 310 portion of element 300, and ultimately through outlets 306 of element 300.

In some embodiments, a thread-wound filtration media of the present disclosure, such as element 300 in FIGS. 3A-3D, may be used in a disc-based filtration system comprising multiple filtration disks, each comprising multiple elements of the present disclosure.

In some embodiments, a disc-based filtration system of the present disclosure is configured to provide fine filtration (>1 μm) over a relatively large filtration area, which provides for low initial pressure differential (<0.04 bar); small footprint; efficient, water-conserving and simple cleaning cycle; and adaptability for various applications and filtration requirements by modification to the filter media used in the system.

In some embodiments, a disc-based filtration system of the present disclosure uses a stack of discs, each comprising a plurality of elements arranged in a planar ring-like arrangement. The discs are connected to a manifold at the center of the disc stack. In some embodiments, each disc offers dual-sided filtration. In some embodiments, filtration flowrate may be determined by a number of discs used in the stack. In some embodiments, a disc-based filtration system of the present disclosure provides for a cleaning/washing cycle wherein the discs are rotated about a central axis of the stack, and a washing liquid spray bar moves across the discs, to wash the surface area of each disc.

Accordingly, in some embodiments, a disc-based filtration system of the present disclosure provides for a drum-like housing having therein a series of stacked discs, each comprised of multiple filtration elements shaped as truncated sectors of a planar ring as described above, wherein the sectors are not connected to a central pipe, thus leaving a central area of the stack free. Rather, the elements can be connected to the housing of the system. The feed fluid to be filtered is let into the system in a direction perpendicular to the disc stack, to pass over the surface of each disc. The flow then passes through the windings of each element, wherein particles in the feed fluid are trapped in the spacing between the windings, and then flows over the surface of the elements, within a gap between the thread windings and a surface of the element and/or within a core channel of the element base, in an axial direction towards one end of the element, and ultimately through outlets of the element. During a cleaning cycle of the filtration system, a rinsing system located within the central area adjacent to the narrow end of the elements, sprays cleansing liquid through nozzles over both sides of the discs. In some embodiments, the nozzles can be rotated by a rotating system, such that the nozzle heads can move in a spiral motion and spray cleansing liquid over the whole area of the discs.

FIG. 4A shows an exemplary disc of a filtration system, in accordance with some exemplary embodiments of the disclosed subject matter. Disc 400 is comprised of a plurality of elements 300 (as shown, e.g., in FIGS. 3A-3D) arranged in a planar ring-like array, wherein a central area of disc 400 remains free.

FIG. 4B shows a cross section of a filter unit 410, comprising multiple discs 400 (shown in FIG. 4A) arranged in a stacked arrangement, wherein each disc 400 comprises multiple elements 300 (shown in FIGS. 3A-3D), in accordance with some exemplary embodiments of the disclosed subject matter.

FIG. 4C shows a filtration system 420, comprising filter unit 410 (shown in FIG. 4B), arranged within a housing, which may be a drum-like cylindrical housing, supported on a platform 422.

FIG. 4D shows inlets and outlets of filtration system 420, in accordance with some embodiments of the disclosure. Filtration system 420 comprises a housing 440, which may be a cylindrical drum-like housing, for housing filter unit 410 (shown in FIG. 4B). A feed fluid to be filtered may enter the filtering system 420 through inlet pipe 432, wherein the filtered fluid may exit through outlet pipe 434. Water or another rinsing liquid can enter filtering system 420 at high pressure through pipe 436 and come out through pipe 432.

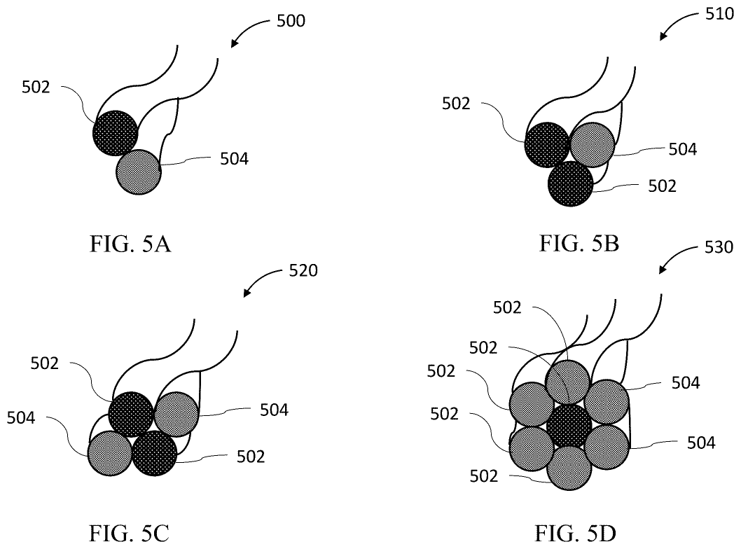

FIGS. 5A-5D show cross-sectional views of various exemplary embodiments of a yarn 500, 510, 520, 530 of the present disclosure. In some embodiments, yarn 500, 510, 520, 530 of the present disclosure comprises a continuous length comprising multiple individual fibers, filaments or threads, that are, e.g., twisted or spun together. In some embodiments, yarn 500, 510, 520, 530 may comprise two or more individual filaments or threads of CNT filament 502, with one or more other thread types, e.g., polymeric thread 504. In some embodiments, yarn 500, 510, 520, 530 or other embodiments of a yarn of the present disclosure may comprise two or more individual filaments or threads, e.g., 2, 3, 4, 5, 6, 7, 8, 9, 10, or more filaments or threads, arranged in a twisted or spun arrangement. In some embodiments, a ratio between a number of CNT filaments or threads 502 to a number of polymeric threads 504 in a yarn of the present disclosure may be, e.g., 1:1, 1:2, 1:3, 1:4, 1:5, 2:1, 3:1, 4:1, 5:1, etc.

### Application of Electric Current to CNT-Based Filtration Media

In some embodiments, the present disclosure aims to enhance the antibacterial properties of CNT-based filtration media of the present disclosure by applying an electric current to the media. In some embodiments, application of an electric current (direct or alternating current) may provide for reducing and/or controlling development of biofilm over the filtration media. In some embodiments, electrification of the CNT threads incorporated in the filtering media may provide for enhancing the inherent antimicrobial properties of CNT.

In some embodiments, the present disclosure aims to enhance the antibacterial properties of filtration media incorporating CNT filaments or threads of the present disclosure by applying an electric current to the media during operation, e.g., continuously or intermittently. In some embodiments, application of an electric current (e.g., direct or alternating current) may provide for reducing and/or controlling development of biofilm over the filtration media. In some embodiments, application of an electric current may provide for enhancing the inherent antimicrobial properties of CNT. In some embodiments, the present disclosure provides for applying an electric current over the filtration media incorporating CNT filaments or threads, to increase anti-fouling properties of the filtration media. In some embodiments, this process takes advantage of the high conducting properties of CNT. In some embodiments, the applied electric voltage may be direct current (DC) voltage or alternating current (AC) voltage.

In some embodiments, the present disclosure provides for applying a constant and/or intermittent low voltage electric charge over the filtration media to increase anti-fouling properties of the filtration media. In some embodiments, the present disclosure takes advantage of the electrical conductivity properties of CNT (e.g., −40,000 S/m), which do not deteriorate when immersed in water, to apply an electric voltage to thread-based filtration media of the present disclosure, e.g., wound thread filtration element 300 (as shown in FIGS. 3A-3D) and/or sheaf-based filtration device 200 (as shown in FIGS. 2A-2B).

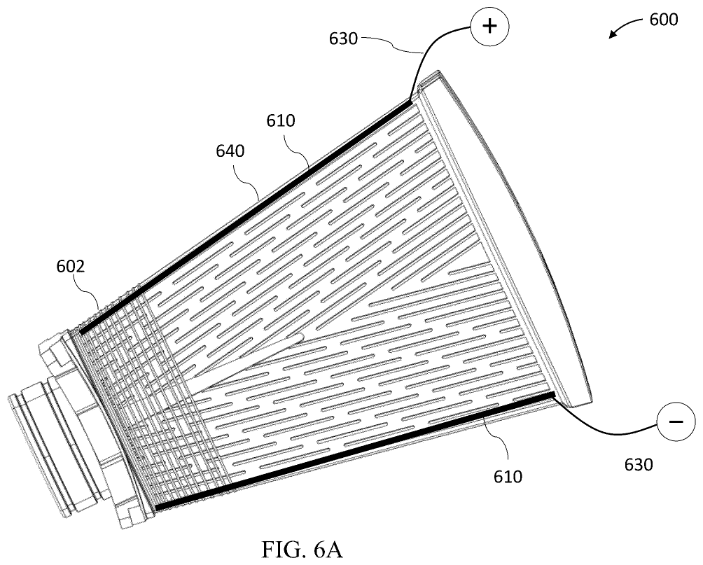

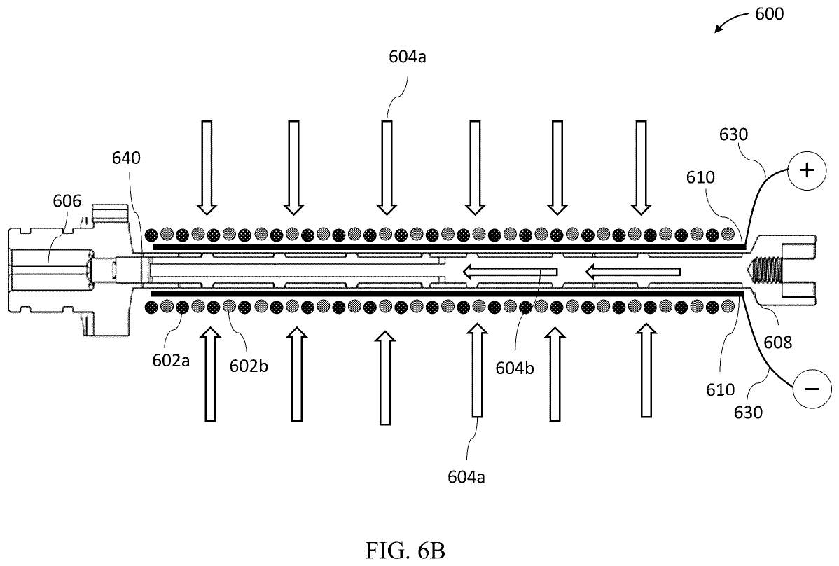

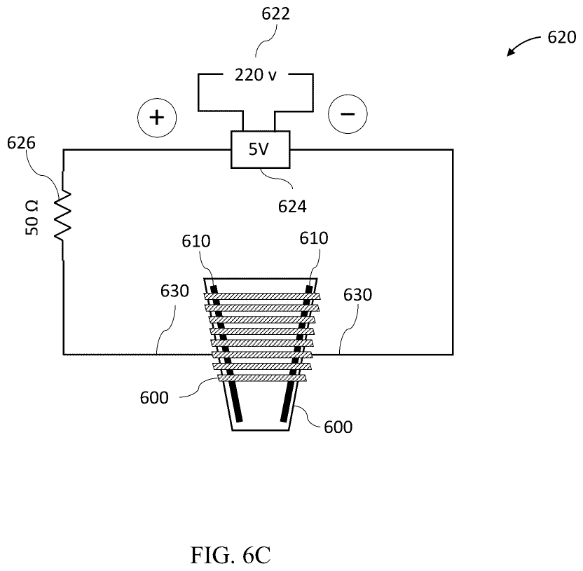

FIGS. 6A-6B show an exemplary wound-thread filtration element 600 in perspective (FIG. 6A) and longitudinal cross-sectional side (FIG. 6B) views, according to some embodiments of the present disclosure. In some embodiments, element 600 may be configured for application of an electric voltage thereto, to provide for enhanced antibacterial properties.

As can be seen in FIG. 6B, in some embodiments, element 600 may be wound using wound threads which comprise CNT filaments or threads 602a alone or a combination with polymeric threads 602b. In some embodiments, element 600 comprises two electrodes 610 extending along a longitudinal dimension of base 640 of element 600, in electric contact with at least a portion of wound CNT filaments or threads 602a wound about base 640. In some embodiments, electrodes 610 are connected to an electrical circuit configured to apply an electrical voltage to electrodes 610. In some embodiments, electrodes 610 may be made according to any conductive material suitable for water-based applications, e.g., copper.

FIG. 6C shows an exemplary electrical circuit 620 configured to apply electric voltage to element 600, to induce electric current flow over CNT filaments or threads 602 wound about base 640 of element 600. In some embodiments, electric circuit 620 may be connected to electrodes 610 of element 600, e.g., through leads 630, to provide a low-voltage electric charge over CNT filaments 602 of element 600. In some embodiments, electric circuit 620 comprises, e.g., a power source 622, which may be a grid-based power source, a converter 624 configured to reduce a voltage of power source 622 to e.g., 5 v, or, e.g., between 0.1 v-24 v. In some embodiments, the electric voltage applied by circuit 620 may comprise direct current (DC) voltage or alternating current (AC) voltage. In some embodiments, electric circuit 622 comprises an optional resistance source 626, e.g., a 50 Ohm resistor or any resistor within the range 10 to 200 Ohm, to operate circuit 622 in a resistive mode. In some embodiments, electric circuit 622 may be configured to provide any combination of: (i) direct current (DC) or alternative current (AC), (ii) a voltage in the range of 0.1 v-24 v, and (iii) a resistance source in the range of 10-200 Ohm. For example, DC current may be applied by electric circuit 622 with voltages ranging from, e.g., 100 mV to 24,000 mV. In some embodiments, AC may be generated to apply a square wave function, which may comprise a DC bias or offset. For example, with AC current, voltages ranging from, e.g., 100 mVpp (millivolt peak to peak) to 24,000 mVpp may be applied at different frequencies (e.g., 10 Hz-10 kHz), with a DC offset of, e.g., 100-10,000 mV. In some embodiments, a duty ratio of the AC current (e.g., percentage of pulsing time over one cycle) may be between 20-70%, e.g., 50%.

Table 1 below summarizes initial experimental results of the antibacterial effect of applying an electric voltage to a thread-based filtration media of the present disclosure, such as element 600.

TABLE 1

| | Number of Attached Cells to | | | |
|---|---|---|---|---|
| | the Filter Media | | | |
| Alternating Current | Dead | Alive | Total | Dead/Total (%) |
| None | 6 | 1111 | 1117 | 0.5 |
| 1800 mVpp | 21 | 72 | 93 | 22.6 |
| 900 mV, +0.45offset | 96 | 18 | 114 | 84.2 |
| 900 mV, +0.45 offset | 5 | 34 | 39 | 12.8 |
| and resistor | | | | |

### Enhancing Hydrophilic Properties of CNT

In some embodiments, CNT filaments or threads incorporated within filtration media of the present disclosure may undergo one or more treatments, e.g., an electro-oxidation treatment, to enhance hydrophilic properties of the CNT filaments.

In some embodiments, the present disclosure aims to enhance hydrophilic properties of CNT-based filtration media of the present disclosure, by applying an electro-oxidation treatment to at least some of the CNT filaments incorporated into the media of the present disclosure. In some embodiments, increasing a hydrophilic property of CNT-based filtration media of the present disclosure may provide for an enhanced ability to separate, e.g., oil and water, e.g., in application comprising wastewater which include traces of oil, such as industrial applications. In some embodiments, increasing a hydrophilic property of CNT-based filtration media of the present disclosure may provide for an enhanced ability to separate, e.g., oil and water, e.g., in the context of coalescing and/or similar oil separators.

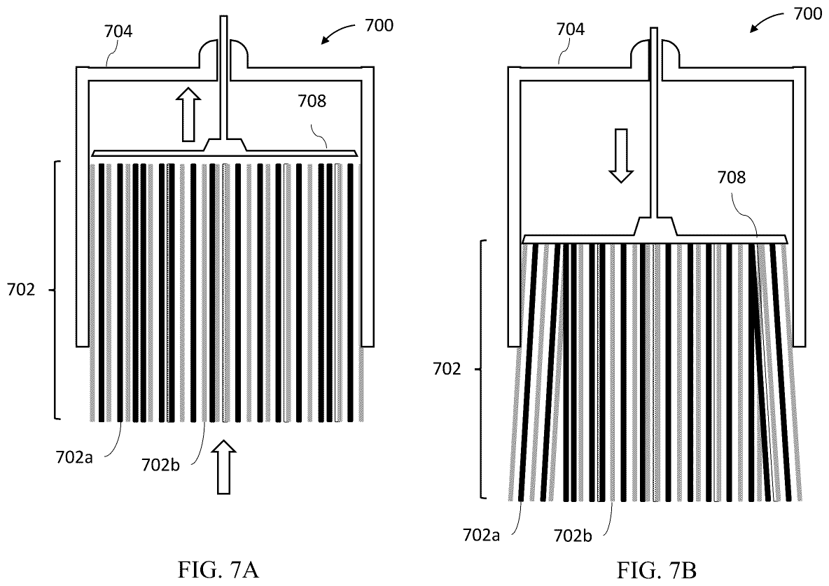

Accordingly, in some embodiments, CNT filaments used in filtration media according to the present disclosure, e.g., element 300 shown in FIGS. 3A-3D, 4A-4D, and/or 6A-6C, and/or sheaf based filtration device shown in FIG. 7 below, may incorporate CNT filaments or threads that have undergone an electro-oxidation treatment ahead of use. In some embodiments, electro-oxidation treatment according to the present disclosure may be performed by applying a specified electric voltage to the CNT filaments or threads to cause electro-oxidation before using the filaments or threads to construct filtration media.

FIGS. 7A-7B show an exemplary sheaf-based filtration device 700 in cross-sectional side view, according to some embodiments of the present disclosure. Sheaf-based filtration device 700 comprises a sheaf-based media, e.g., sheaf 702, comprising multiple yarns or threads. In some embodiments, sheaf 702 comprises a plurality of lengths of filaments, threads, or yarns arranged in a lengthwise arrangement and attached at one end, e.g., to a perforated plate 708. In some embodiments, sheaf 702 may comprise solely CNT filaments or threads. In some embodiments, sheaf 702 may comprise a combination of CNT filaments or threads 702a, and polymeric threads 702b. In some embodiments, sheaf 702 may comprise various ratios of a number of CNT filaments or threads to a number of polymeric threads, e.g., 1:1, 1:2, 1:3, 1:4, 1:5, 2:1, 3:1, 4:1, 5:1, etc.

In some embodiments, sheaf 702 may be held within a cylindrical canister 704, which may be dimensioned for accommodating sheaf 702 in a tight fit. During a filtration stage, shown in FIG. 7A, fluid passes within cylindrical canister 704 in a filtration flow direction, as shown in FIG. 7A. The fluid pressure urges sheaf 702 into cylindrical canister 704, wherein sheaf 702 compresses and an inter-thread spacing within sheaf 702 decreases. The fluid typically flows substantially lengthwise along the threads of the sheaf, wherein particles may be trapped within the inter-thread spacing.

In some embodiments, as shown in FIG. 7B, sheaf-based filtration element 700 may be configured for performing a cleaning cycle. During such a cleaning cycle, a washing fluid may flow in the opposite direction, urging sheaf 702 outside of cylindrical canister 704. Once outside, sheaf 702 loosens, thereby increasing inter-thread spacing. The washing fluid then may wash substantially lengthwise along the length of the threads, to dislodge particles trapped within the threads of sheaf 702 and carry them away in the flow direction.

Experimental Results

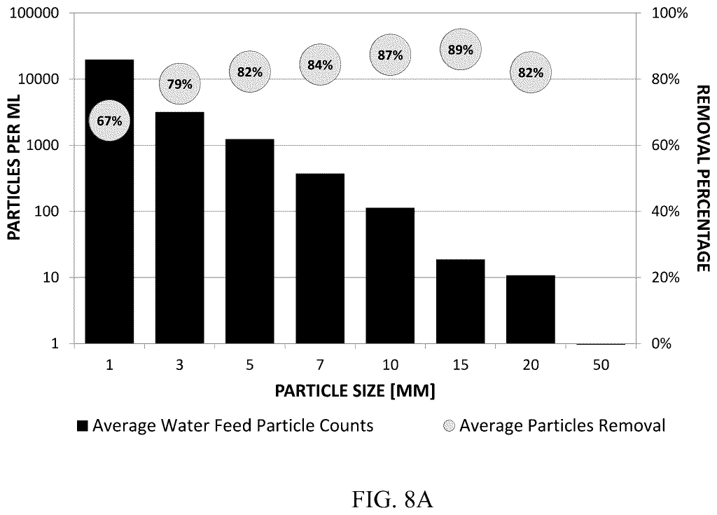

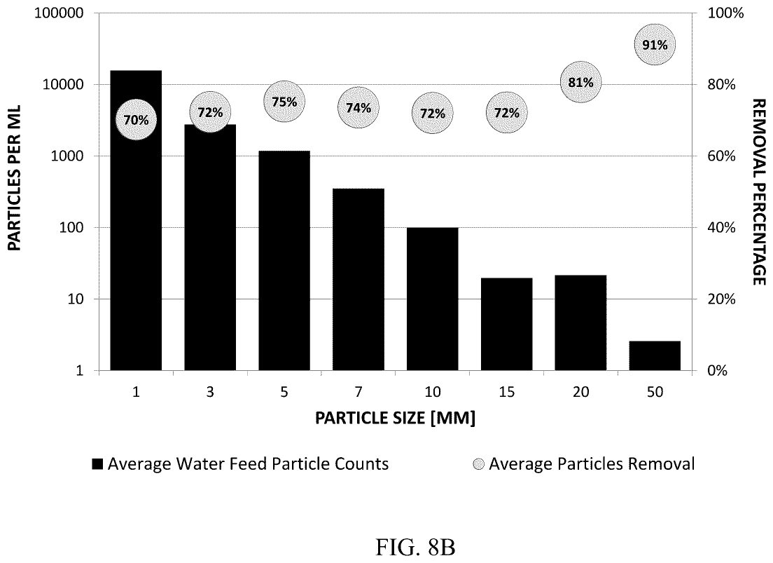

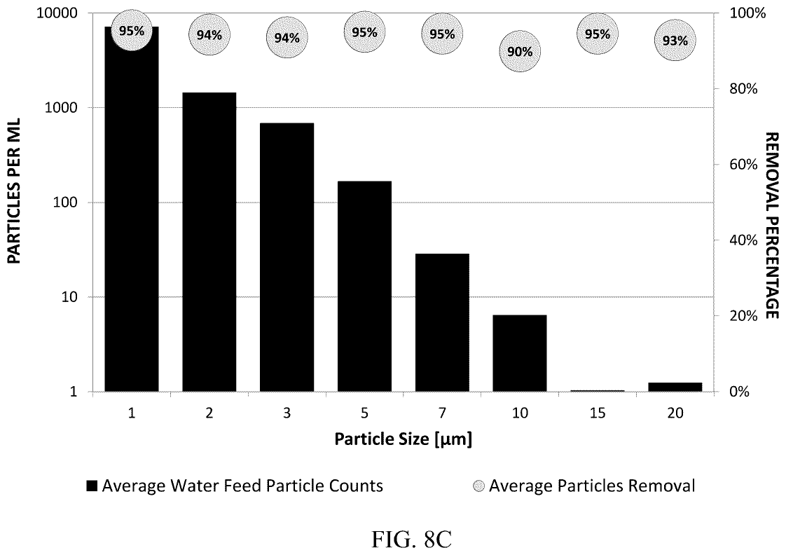

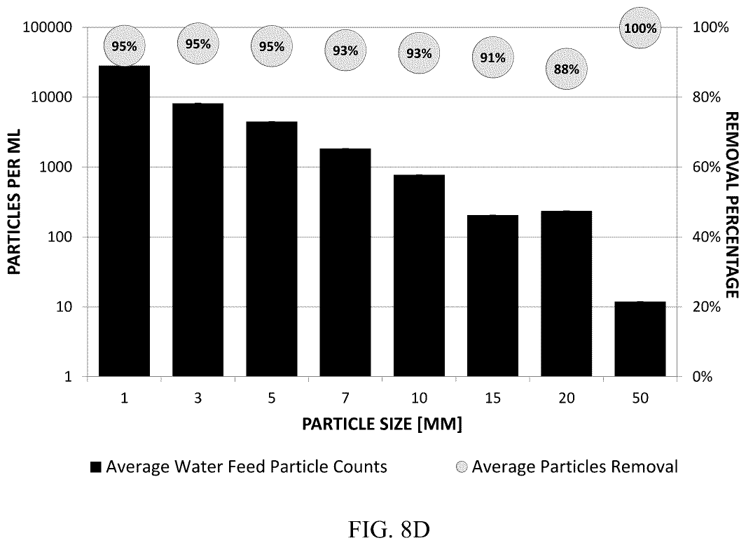

FIGS. 8A-8D show experimental results of filtration using media of the present disclosure. FIGS. 8A and 8B show filtration results using a wound-thread filtration element, e.g., filtration element 300 as shown in FIGS. 3A-3D. in FIG. 8A, the filtration element was wound with 10 layers of a yarn comprising 1 CNT filament and 1 polymeric (PET) thread. In FIG. 8B, the filtration element was wound with 10 layers of a yarn comprising 1 CNT filament and 3 polymeric (PET) thread. In FIG. 8C, the filtration element was wound with 2 inner layers of a yarn comprising 3 CNT filament, and 12 external layers of a polymeric (PET) thread. In FIG. 8D, the filtration element was wound with 2 inner layers of a CNT filament and 10 external polymeric (PET) thread.

Results of experiments conducted by the present inventors are summarized in tables 2 and 3 below. As can be seen, a wound-thread filtration media incorporating CNT filaments according to some embodiments of the present disclosure may provide for similar and/or enhanced filtration efficiency as compared to polymeric-based filtration media, as detailed in Table 2 below.

TABLE 2

| Efficiency Parameter | Quantitative Target |
|---|---|
| Filtration efficiency of | ≥90% Removal for particles of ≥2 |
| suspended solids | μm |
| Source water parameters: | ≥97% Removal for particles of ≥10 |
| NTU ≤15; TSS ≤25) | μm |
| Wash cycle efficiency | Recovery to initial filtration efficiency |
| | (±5%) and differential pressure |
| | (±10%) even after thousands of cycles. |
| Wash water consumption | <=1% of total cycle volume |
| Initial pressure differential | <=0.04 bar |
| Oil water separation efficiency | Reduction in range of 75%-95% |
| Leaching of nanocarbon | No leachates detected |
| particles into water | |

Similarly, a wound-thread filtration media incorporating CNT filaments according to some embodiments of the present disclosure may provide for one or more further advantages, as detailed in Table 3 below.

TABLE 3

| | | Polymeric | |
|---|---|---|---|
| Parameter | CNT based filter | Thread Disc | Sand Filter |
| Life span of | 5-7 years | 4-5 years | 2-3 years |
| filtration media | (+25%-30%) | | |
| Chemicals and | None | Very little | Very frequent |
| chemical cleanings | | | |
| Water demand for | ~1% | ~1.5% | ~4-5% |
| cleaning | (+50%) | | |
| Energy demand | Avg. 0.1 bar | Avg. 0.12 bar | Avg. 0.35 bar |
| | (+20%-25%) | | |
| Increase in media | + 20%-25% | +10%-15% | Reference point |
| life span | | | |

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

1. A filtration element comprising a thread-based medium comprising one or more threads, wherein each thread comprises at least one filament of carbon nanotube (CNT), and wherein said filtration element is configured to filter a feed fluid based on a filtration operation wherein said feed fluid passes through said thread-based medium.

2. The filtration element according to claim 1, wherein said thread-based medium comprises at least one continuous thread wound about a filter base in a series of windings defining at least one layer, and wherein, during said filtration operation, said feed fluid passes between said series of windings in said at least one layer.

3. The filtration element according to claim 2, wherein said at least one continuous thread is a CNT thread.

4. The filtration element according to claim 2, wherein said at least one continuous thread is a yarn comprising at least one filament of CNT and at least one filament of a polymeric material.

5. The filtration element according to claim 4, wherein a ratio between a number of said filaments of CNT and said filaments of said polymeric material is one of: 1:1, 1:2, 1:3, 1:4, 1:5, 2:1, 3:1, 4:1, and 5:1.

6. The filtration element according to claim 2, wherein said filter base defines a planar body comprising at least one filtration face, wherein said feed fluid passes through said at least one layer to collect at said at least one filtration face, and wherein said collected feed fluid flows towards an outlet of said filtration element.

7. The filtration element according to claim 6, wherein said at least one filtration face comprises a plurality of protrusions which support said at least one layer to create a gap between said at least one layer and said at least one filtration face, and wherein said feed fluid collects within said gap.

8. The filtration element according to claim 6, wherein said at least one filtration face comprises a plurality of openings, and wherein said feed fluid flows through said plurality of openings to collect within a core of said filter base.

9. The filtration element according to claim 2, wherein said at least one continuous thread comprises at least one polymeric thread that is wound about said filter base in a series of windings defining at least one polymeric layer.

10. The filtration element according to claim 9, wherein said at least one polymeric layer is an outermost layer of said filtration element.

11. The filtration element according to claim 2, wherein said at least one layer is wound according to winding parameters selected from the group consisting of: a space between successive windings in said series of windings, and a tension applied to said thread during said winding.

12. The filtration element according to claim 2, comprising between 2-15 of said layers.

13. The filtration element according to claim 2, wherein said filter base is shaped as a sector of a planar ring, and wherein a plurality of said filter bases are configured to be connected side-to-side to form said planar ring.

14. The filtration element according to claim 13, wherein a plurality of said planar rings are configured to be stacked, to form a stacked filtration unit, and wherein said stacked filtration unit is housed within a housing to form a filtration system.

15. The filtration element according to claim 2, wherein said filter base comprises at least two electrodes configured to be in electric contact with at least a portion of said continuous thread, and wherein said at least two electrodes are connected to an electric circuit configured to apply an electric voltage to said continuous thread.

16. The filtration element according to claim 1, wherein said at least one filament of CNT undergoes an electro-oxidation treatment.

17. The filtration element according to claim 1, wherein said thread-based medium comprises a plurality of said threads, wherein each of said threads comprises at least one filament of CNT, and wherein said threads are arranged lengthwise into a sheaf between a first end and a second end of said medium.

18. The filtration element according claim 17, wherein said plurality of threads are attached at said first end and are unattached at said second end.

19. The filtration element according to claim 18, wherein said medium is housed within a housing having a first opening and a second opening, and wherein said first end is oriented toward said first opening of said housing, and said second end is oriented toward said second opening.

20. The filtration element according to claim 19, wherein said housing defines a cylindrical canister having a smaller cross-sectional first portion adjacent said first opening, and a larger cross-sectional second portion adjacent said second opening, and wherein said thread-based medium is configured to move lengthwise within said housing between said first and second portions.

21. The filtration element according to claim 20, wherein (i) said first portion is configured to decrease a spacing between said plurality of threads when said thread-based medium is located within said first portion, and (ii) said second portion is configured to allow an increase in said spacing between said plurality of threads when said thread-based medium is located within said second portion.

22. The filtration element according to claim 21, wherein, during said filtration operation, said feed fluid passes through said housing from said second opening substantially lengthwise along said threads toward said first opening, when said thread-based medium is located within said first portion.

23. The filtration element according to claim 21, wherein said thread-based medium is configured to be cleaned based on a cleaning cycle wherein a washing fluid passes through said housing from said first opening substantially lengthwise along said threads toward said second opening, when said thread-based medium is located within said second portion.

24. A method comprising:
providing a filtration element comprising a thread-based medium comprising one or more threads, wherein each thread comprises at least one filament of carbon nanotube (CNT), and wherein said filtration element is configured to filter a feed fluid based on a filtration operation wherein said feed fluid passes through said thread-based medium; and
feeding, during said filtration operation, said feed fluid such that said feed fluid flows over said filtration element and passes through said thread-based medium.

25-45. (canceled)
